(19) United States
(12) Patent Application Publication
(10) Pub. No.: US 2002/0136946 A1
(43) Pub. Date: Sep. 26, 2002

(54) High voltage rechargeable electrochemical energy storage system structure

(76) Inventors: Glenn G. Amatucci, Peapack, NJ (US); Duncan Culver, Howell, NJ (US)

Correspondence Address: David A. Hey, Esq., Telcordia Technologies, Inc., 445 South Street - Room 1G-112R, Morristown, NJ, 07960, US

(21) Appl. No.: 09/813,414

(22) Filed: Mar. 21, 2001

(51) Int. Cl. H01M 2/02

(52) U.S. Cl. 429/152; 429/153; 429/210; 429/176

(57) ABSTRACT

A rechargeable electrochemical energy storage cell structure capable of providing high voltage operation comprises a plurality of electrode and separator member assemblies comprising individual cells disposed in electrical series circuit arrangement with interposed electrically conductive divider members and sealed within an enveloping casing. Each divider member engages the casing to form sealed compartments for the individual electrochemical cell assemblies in order to prevent migration of electrolyte which might otherwise result in deleterious ionic shorting between electrodes of opposite charge and comprising separate component cells.

### BACKGROUND OF THE INVENTION

The present invention relates to a rechargeable electrochemical energy storage system structure, particularly such a structure which is capable of providing high voltage by virtue of an integral electrical series arrangement of a plurality of individual rechargeable electrochemical cells.

A number of rechargeable electrochemical energy storage system products are available which essentially comprise an integral arrangement of a negative electrode layer member, a positive electrode layer member, and an interposed electrically insulating, ion-conducting separator layer member, usually compressed within a rigid casing or laminated to form a unitary cell structure. In addition to providing electrically insulative separation between the electrode members, the separator also provides critical ion conductivity, usually derived from an incorporated or absorbed electrolyte solution of a dissociable salt in a non-aqueous solvent. Further, the ionic conductivity of the electrode layers, and thus operation of the cell, is often enhanced by absorption of electrolyte in those cell members, as well.

The voltage level of electrical energy delivered by a storage cell, whether, for example, an ion-intercalation battery cell, a supercapacitor cell, or an asymmetric hybrid cell, is known to be characteristically established by the electromotive relationship of the respective electrochemically active materials comprising the electrode members of the cell. Thus, while the capacity of a cell to store electrical energy may be varied by the amount of incorporated active electrode material, the voltage level of electrical energy recovered upon cell discharge is substantially fixed by electrode composition.

The problem of providing a source of higher voltage electrical output given cells of lower characteristic voltage level has usually been remedied through the expedient of arranging two or more such cells in an electrical series circuit, thus raising the output voltage by a multiple of the basic cell voltage. However, while the desired end of increased voltage may be achieved in this manner, the specific capacity of the resulting battery arrangement suffers considerably due to the added non-productive weight of the agglomeration of extraneous duplicated cell members, connecting conductors, and packaging materials. This factor seriously detracts from the marketability of such multiple-unit products, especially where miniaturization of the utilizing device is of utmost concern.

Attempts have heretofore been made to incorporate in series relationship within a single storage structure only essential members of multiple cells, such as electrodes and separators, utilizing in common wherever possible non-productive members, such as current collectors and packaging. Such condensed, multi-cell storage structures have been suggested, for instance, in U.S. Pat. No. 5,478,668.

It has now been discovered, however, in the present investigations that the mobile nature of cell electrolyte which contributes so significantly to rechargeable cell performance has a deleterious effect in a multiple cell arrangement. In essence, despite meticulous precautions to limit excess electrolyte within such an arrangement, the ability of electrolyte to eventually migrate among multiple cell members and ultimately provide ion-conductive continuity between opposite-polarity electrodes comprising different constituent cells results in shorting which leads to irreparable harm in the operation of the composite storage structure.

The present invention provides a multiple cell series structure which prevents undesirable intercell electrolyte migration and thus enables continuous, stable, high-voltage performance of electrochemical cell storage systems having such a unique structure.

### SUMMARY OF THE INVENTION

The unique structure of the present invention comprises a plurality of electrochemical cells each comprising a positive electrode member, a negative electrode member, and an interposed separator member comprising an electrolyte, typically a solution of a dissociable salt source of mobile cell ions in a non-aqueous solvent. Each such cell is disposed in electrical series arrangement with another cell, i.e., with respective electrode members of opposite polarity in parallel coextension, and an electrolyte-impenetrable, ion-insulating, electron-conducting cell divider member interposed in contiguity with those facing cell electrodes. The divider member extends beyond the periphery of the coextensive cell electrode arrangement and is sealed to an encompassing outer body casing member material which provides an environmental enclosure for the cell plurality arrangement. In this configuration, the one or more divider members maintains the constituent cells in ionic isolation, yet provides electrical continuity between each series pair of such cells.

Cells incorporated into the series structure of the present invention may be any type of electrical energy storage cell comprising lithium or other mobile cations in such configurations as ion intercalation battery cells, supercapacitor cells, or asymmetric hybrid cells combining aspects of those two general cell types. Also, there may be employed in the invention either of the major cell fabrication styles, e.g., the rigid metal casing compression style typified by the well-known “button” battery, or the semi-rigid or flexible film-encased laminated component polymer layer style of more recent development. Yet other embodiments of the invention may be realized in various combinations of cells within a series structure which may include a plurality of more than two individual cells in order to yield still higher output voltage.

### BRIEF DESCRIPTION OF THE DRAWING

The present invention will be described with reference to the accompanying drawing of which:

FIG. 1 depicts schematically in cross-section elevation a typical rechargeable electrochemical energy storage cell currently in general use;

FIG. 2 depicts schematically in cross-section elevation a multicell rechargeable electrochemical energy storage system structure suggested in the prior art;

FIG. 3 depicts schematically in plan view an embodiment of a rechargeable electrochemical multicell energy storage structure of the present invention;

FIG. 4 depicts schematically in cross-section elevation, taken at 4-4, the embodiment of FIG. 3;

FIG. 5 depicts schematically in cross-section elevation another embodiment of the present invention;

FIG. 6 depicts the plotted recycling voltage profile of an asymmetric hybrid single cell electrochemical storage structure;

FIG. 7 depicts the plotted recycling voltage profile of an asymmetric hybrid two-cell series electrochemical storage structure embodiment of the present invention;

FIG. 8 depicts the plotted recycling voltage profile of a supercapacitor single cell electrochemical storage structure; and

FIG. 9 depicts the plotted recycling voltage profile of a supercapacitor two-cell series electrochemical storage structure embodiment of the present invention.

### DESCRIPTION OF THE INVENTION

A typical rechargeable single cell electrochemical energy storage structure 10, as depicted in FIG. 1, comprises a positive electrode member 13, a coextensive negative electrode member 17, and an interposed ion-conductive, electron-insulative separator member 15. This separator member will normally comprise a layer of fibrous glass or the like, microporous polyolefin, or absorptive polymer which is capable of inertly taking up and retaining any of the numerous non-aqueous solutions of electrolyte salts in common use in this art.

In order to facilitate application of charging current and recovery of stored energy, the cell often further comprises electrically conductive current collector members 11, 19 coextensively contiguous with respective electrode members 13, 17. Such collector members are normally fabricated of metallic foil or electrically conductive polymer composition, or may simply constitute a metallic structural element of cell casing. If subsequent fluid processing of a cell, such as solvent extraction of plasticizer or insertion of electrolyte solution, is anticipated, at least one collector member of the cell may preferably be in the form of reticulated foil mesh.

Numerous combinations and compositions of electrode members 13, 17 are known and employed throughout the art. For example, a well-known rechargeable battery cell, such as described in U.S. Pat. No. 5,840,087, comprises a positive electrode 13 of lithium intercalation spinel, LiMn₂O₄, and a negative electrode 17 of petroleum coke. This combination of active electrode components yields, with a commonly used polymeric separator member 15 containing electrolyte comprising a 1 M solution of LiPF₆ in mixture of equal parts of ethylene carbonate (EC) and dimethylcarbonate (DMC), a single cell providing an effective battery having a long, stable operation in the recycling voltage range of about 2.5-4.0 V.

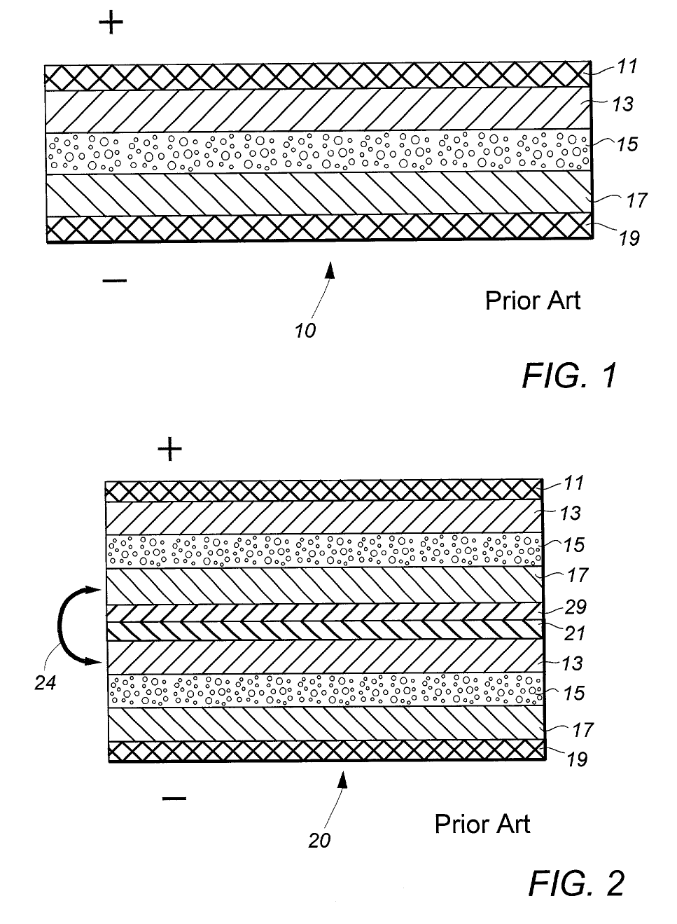

Attempts have previously been made, as in above-noted U.S. Pat. No. 5,478,668, to increase the operating voltage of an intercalation battery having the above composition by a factor of two, i.e., to a range of about 5.0-8.0 V, by simply arranging two such cells in series contiguity, as shown in FIG. 2. There, a first cell comprising respective positive and negative electrodes 13, 17 would be placed in contact with a second, identical cell in such a manner that negative current collector 29 of the first contacted positive collector 21 of the second. The composite two-cell battery structure 20 would then have been activated with electrolyte solution prior to sealing in an enclosing protective polymeric envelope, this latter member not being shown for the sake of clarity. While a replication of this prior series cell structure provided an initial output of increased voltage, such output almost immediately decreased to a negligible level as the battery function rapidly deteriorated. This failure, upon investigation, was determined to be attributable to ionic shorting between the opposite polarity electrodes 17, 13, as via a path 24 apparently existing in migrated electrolyte.

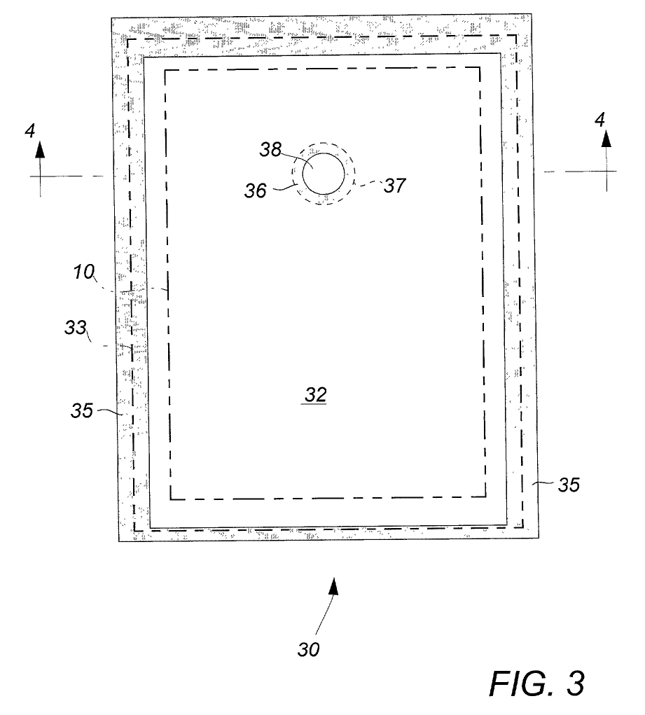

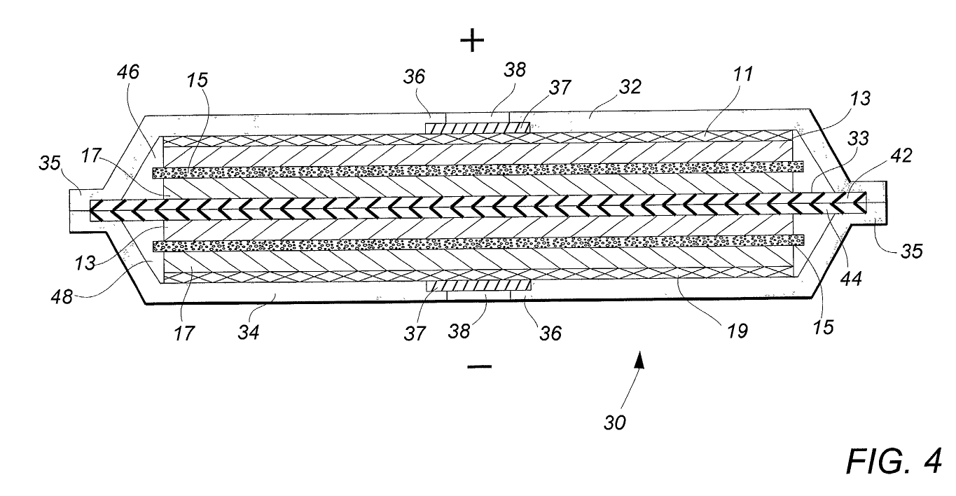

A two-cell embodiment 30 of a rechargeable electrochemical series cell structure according to the present invention which remedies this noted shortcoming of earlier attempts to provide increasing voltage levels in energy storage systems may be seen in plan view in FIG. 3. As shown in that view, the structure, of which greater detail may be seen in FIG. 4, comprises a pair of substantially coextensive, overlaid casing or envelope members 32, 34, of which upper member 32 only is visible in this view. Between such envelope members 32, 34 are situated, overlaid in series arrangement, a pair of substantially coextensive rechargeable cells of the type seen at 10 in FIG. 1, the relative position of the lesser periphery of these cells being shown at 10 in this view. Further, interposed between cells 10 at a position indicated by its intermediate periphery 33 is a divider layer member of electrically conductive, ion-insulative material.

With the noted structural members in those relative positions, the contiguous peripheral regions 35 of envelope members 32, 34 are sealed together by thermal adhesion of polymeric envelope material, mechanical clenching of metallic casing material, or other appropriate means, while simultaneously engaging and affixing to the casing the peripheral region of divider member 33 to form individual envelopes or casing enclosures physically and ionically isolating the respective electrochemical cells 10 while establishing a series electrical circuit between their opposite polarity electrode members. In addition, where a normally insulative polymeric material is employed as envelope members 32, 34, multiple cell structure 30 may include an opening 38 communicating with the underlying current collector of cell 10 and sealed at its peripheral region 36 to envelope member 32 in order to provide access for electrical terminal contact with the current collector. Where such collector member comprises a comparatively delicate reticulated foil mesh material, an additional conductive contact member 37 of greater strength may be included similarly sealed to envelope member 32.

A cross-sectional elevation view of series cell structure 30 taken at line 4-4 of FIG. 3 may be seen in FIG. 4. The represented cell members are shown, for example, as comprising typical laminated polymeric Li-ion intercalation cells such as mentioned above with respect to FIG. 1 in which the active electrode materials may be LiMn₂O₄ in positive electrodes 13 and petroleum coke in negative electrodes 17. Separator members 15 with which the electrode members are laminated may comprise plasticizer-extracted vinylidene fluoride : hexafluoropropylene (VdF:HFP) copolymer membranes. Outermost current collector members 11, 19 associated with respective positive and negative members 13, 17 may be reticulated foil grid to facilitate fluid processing, while, according to the present invention, an extended conductive, ion-insulative divider member 33 is interposed between electrode members 17, 13 of opposed polarity. Divider 33 may comprise a bimetallic foil of aluminum and copper layers 42, 44 usually preferred for optimum electrochemical compatibility with the active materials of electrodes 17, 13, particularly in environments of the greater negative potentials encountered with intercalation cells, and may replace innermost current collector members 19, 11 in the interest of eliminating redundant weight.

As seen further in FIG. 4, the resulting series arrangement of battery cell components is encompassed in upper and lower casing members 32, 34 which engage the periphery of divider member 33, e.g., in heat-sealed contiguous regions 35 of a thermoplastic laminate envelope casing material, to form individual isolation compartments 46, 48 for the respective electrochemical cells. Also depicted is the noted option of terminal contact openings 38 with added contact members 37 adhered to encasing film 32, 34 at regions 36 to maintain the hermetic seal of the cell compartments.

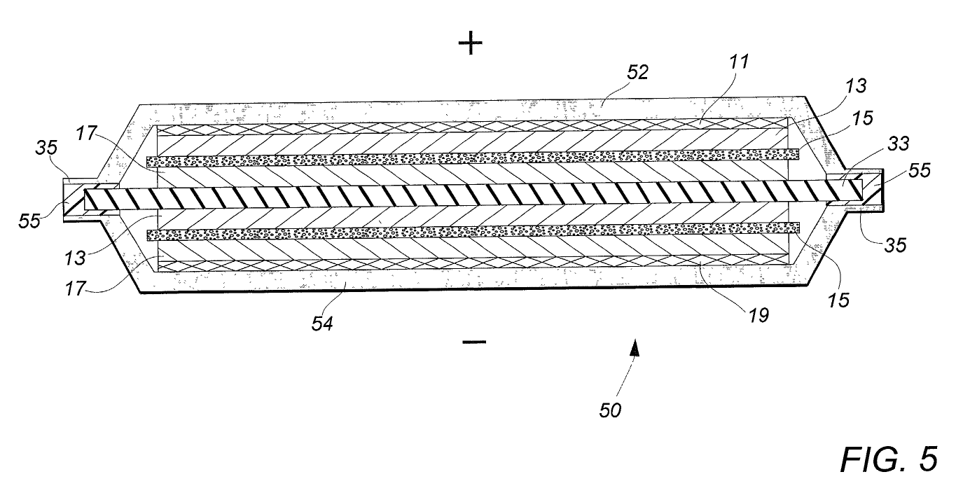

Another embodiment 50 of the present invention is depicted in FIG. 5 where encasing members 52, 54 are shown to represent electrically conductive material, such as metal case components or conductive polymer film. The conductivity of such members enables direct terminal contact with respective outer surfaces of envelope or casing members 52, 54, thus providing an alternative to terminal contact access openings. In order to maintain the component cells in series circuit arrangement, intermediate insulating sealing member 55 is interposed between enclosure regions 35 and conductive divider member 33. This divider member 33 may be the previously noted bimetal material of Li-ion cell fabrications or may be a simple conductive foil used with other desirable cell configurations comprising supercapacitors or asymmetric hybrid energy storage cells. Additional alternative embodiments may comprise these latter type cells in polymeric envelope configurations as depicted in FIG. 4.

A number of configurations of the invention were prepared and tested in repetitive cycling over extended periods of time to determine the efficacy and stability of the resulting high voltage series cell structures. The respective electrode compositions of such cells were similar to those employed previously in a variety of single cell electrical energy storage systems.

### EXAMPLE I

For use as a comparative counter-example to an embodiment of the present invention, a single asymmetric hybrid electrochemical cell of a structure depicted in FIG. 1 was prepared to include a positive electrode member 13 cast as a layer from an acetone solution comprising 10.0 parts by weight of high surface area (1500 m²/g) activated carbon powder, 20.0 parts of 88:12 VdF:HFP copolymer, and 30.0 parts of dibutyl phthalate (DBP) plasticizer. Negative electrode member 17 was similarly prepared from a solution comprising 10.5 parts of Li₄Ti₅Ol₂, 1.2 parts of Super-p conductive carbon, 2.8 parts of VdF:HFP copolymer, and 4.3 parts of DBP. Separator member 15 was likewise cast from a solution comprising 6.0 parts of VdF:HFP copolymer, 10.0 parts of DBP, and 4.0 parts of fumed silica powder. Electrode members 13, 17 were respectively heat-laminated to aluminum and copper foil mesh current collectors 11, 19 and these sub-assemblies were then similarly laminated with separator member 15 to provide the cell structure shown in FIG. 1. Fabrication of the single asymmetric cell was completed for operation by immersing the structure in diethyl ether to extract the DBP plasticizer component and then in a 1 M solution of LiPF₆ in a 1:1 mixture of EC:DMC to imbibe activating electrolyte. The single cell structure was finally hermetically sealed in a polymeric envelope casing with conductor elements affixed to the respective current collector members 11, 19 and communicating with the exterior of the cell casing.

### EXAMPLE II

A corresponding series cell structure of the present invention was fabricated from the electrode and separator materials described in Example I. Separate partial single cell structures were initially prepared by laminating respective assemblies of collector, electrode, and separator members 11, 13, 15, 17 and 13, 15, 17, 19. These sub-assemblies were then laminated with a bimetal divider member 33, extracted, and activated with electrolyte solution prior to being sealed between envelope casing members 32, 34 substantially as shown in FIG. 4.

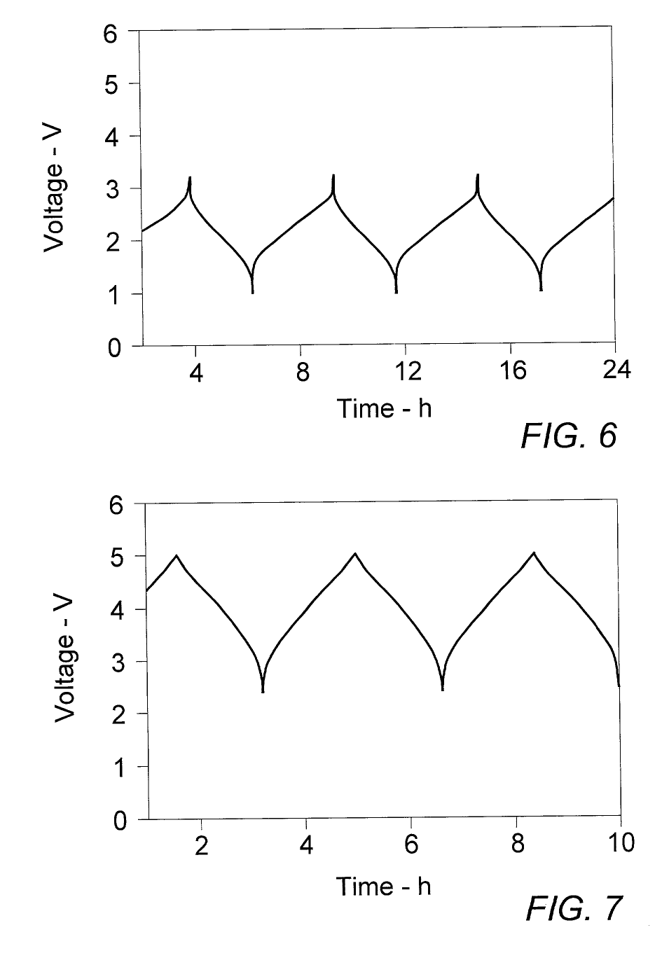

The respective activated cell structures of Examples I and II were tested in circuit with a widely used automatic cycle-control and data-recording apparatus over charge/discharge cycling periods of many hours. The variations in charging and output voltages exhibited by the energy storage systems were plotted and provided the traces represented in FIG. 6 for the single cell of Example I and in FIG. 7 for the series cell structure of Example II. The stable operation and range of substantially doubled voltage shown in FIG. 7 attest to the efficacy of the series cell structure of the present invention.

### EXAMPLE III

As a comparative counter-example to a different energy storage system embodiment of the present invention, a single supercapacitor electrochemical cell of a structure depicted in FIG. 1 was prepared from the activated carbon electrode and polymer separator compositions of Example I. Thus, to fabricate a single cell structure of FIG. 1, separate laminated sub-assemblies 13, 11 and 17, 19 of activated carbon electrode and aluminum current collector were laminated with interposed separator 15. The structure was then processed as described in Example I to yield a sealed, activated single cell supercapacitor system.

### EXAMPLE IV

As in the manner of Example II, two partial cells of Example III were laminated with an interposed aluminum foil divider member 33, activated with electrolyte, and sealed in an envelope casing to yield a multi-cell supercapacitor series structure as generally depicted at 30 in FIG. 4.

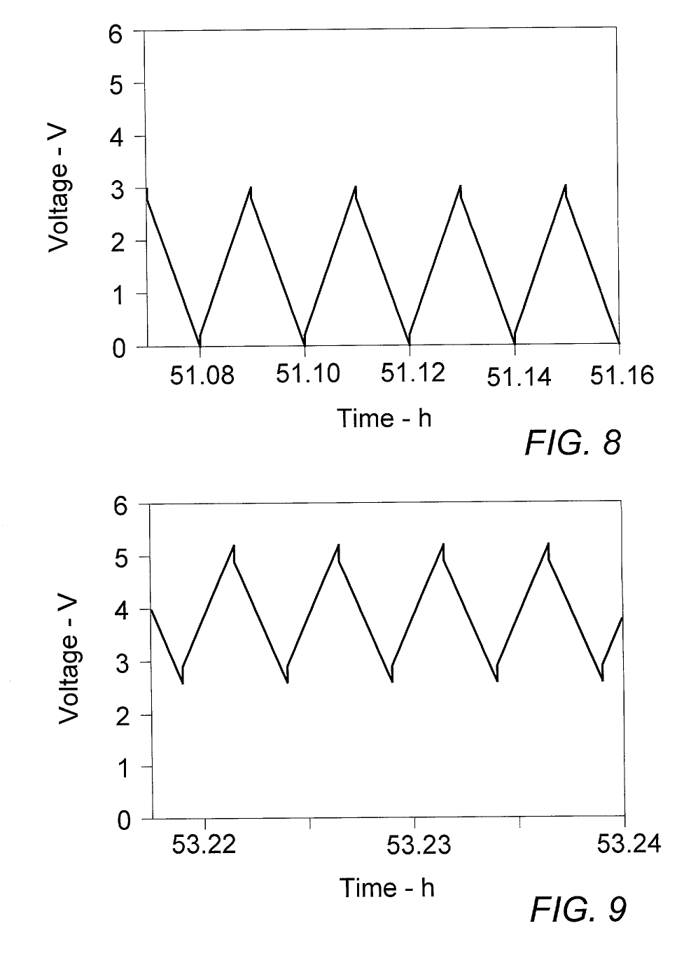

The respective activated cell structures of Examples III and IV were tested in above-noted manner over prolonged charge/discharge cycling periods. The variations in charging and output voltages exhibited by the supercapacitor energy storage systems were plotted and to yield the cycle traces represented in FIG. 8 for the single cell of Example III and in FIG. 9 for the series cell structure of Example IV. An essentially undiminishing capacity of about 0.9 mAh throughout a test period in excess of 1.5×10⁴ cycles and a stable operating range of substantially doubled voltage as shown in FIG. 9 further attest to the extraordinary performance of the series cell structure of the present invention.

It is anticipated that other embodiments and variations of the present invention will become readily apparent to the skilled artisan in the light of the foregoing description and examples, and it is intended that such embodiments and variations likewise be included within the scope of the invention as set out in the appended claims.

What is claimed is:

1. A high voltage rechargeable electrochemical energy storage system structure comprising an electrical series arrangement of a plurality of individual rechargeable electrochemical cells, each cell comprising a pair of opposed polarity electrode members and a separator member providing an electrolyte interposed between said electrode members, where said structure is arranged such that:
an electrode member of first polarity of a first cell is adjacent an electrode member of second polarity of a second cell;
an electrically conductive divider member is interposed contiguously between said electrode member of said first cell and said electrode member of said second cell;
said plurality of cells is enveloped within a casing; and
said divider member is affixed to said casing and forms therewith a seal isolating ionically each cell from the other cells.

2. A structure according to claim 1 wherein
said casing comprises electrically insulating material; and
said structure further includes means for communicating electrically between at least one electrode member and the exterior of said casing material.

3. A structure according to claim 2 wherein said means for communicating comprises an opening in said casing material through which said electrode member may be accessed.

4. A structure according to claim 2 wherein said means for communicating comprises
an electrically conductive contact member in circuit with said electrode member; and
an opening in said casing material through which said contact member may be accessed.

5. A structure according to claim 1 wherein
said casing comprises electrically conductive material; and
said structure includes means for electrically insulating said divider member from said conductive casing material.

6. A structure according to claim 5 wherein
said casing comprises a first electrically conductive casing member in circuit with an electrode member of first polarity of a first cell and a second electrically conductive casing member in circuit with an electrode member of second polarity of a second cell; and
said structure comprises means for providing electrical insulation between said first and second casing members.
